(19) United States
(12) Patent Application Publication
(10) Pub. No.: US 2004/0144875 A1
(43) Pub. Date: Jul. 29, 2004

(54) Deflection compensating refiner plate segment and method

(75) Inventor: Ola M. Johansson, Brookfield, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: J & L Fiber Services, Inc.

(21) Appl. No.: 09/756,428

(22) Filed: Jan. 8, 2001

(51) Int. Cl. B02C 19/00

(52) U.S. Cl. 241/261.1; 241/298

(57) ABSTRACT

A segment for a rotary disk refiner that has a refining surface offset to compensate for deflection of the segment that occurs during refiner operation. In one preferred embodiment, the refining surface overlying each segment overhang is offset to compensate for deflection that occurs in the region of the overhang during refiner operation. Other regions of the refining surface can also be offset to compensate for deflection. In another preferred embodiment, a mount that extends outwardly from the backside of a segment has a hollow therein to reduce segment mass to reduce refining surface deflection. In a method of making a deflection compensating segment, the location and magnitude of each region of deflection is analytically or experimentally determined and the refining surface is formed with a corresponding offset in each deflection region.

### FIELD OF THE INVENTION

The present invention relates to a refiner plate for a disk refiner and more particularly to a refiner plate segment formed to compensate for deflection that occurs during refiner operation and a method of making such a segment.

### BACKGROUND OF THE INVENTION

Many products we use everyday are made from fibers. Examples of just a few of these products include paper, personal hygiene products, diapers, plates, containers, and packaging. Making products from wood fiber, fabric fiber and the like, involves breaking solid matter into fibrous matter. This also involves processing the fibrous matter into individual fibers that become fibrillated or frayed so they more tightly mesh with each other to form a finished fiber product that is desirably strong, tough, and resilient.

In fiber product manufacturing, refiners are devices used to process the fibrous matter, such as wood chips, fabric, and other types of pulp, into fibers and to further fibrillate existing fibers. The fibrous matter is transported in liquid stock to each refiner using a feed screw driven by a motor.

Each refiner has at least one pair of annular refiner plates that face each other. During refining, fibrous matter in the stock to be refined is introduced into a gap between the plates that usually is quite small. Relative rotation between the plates during operation fibrillates or grinds fibers in the stock as the stock passes radially outwardly between them.

One example of a refiner that is a disk refiner is shown and disclosed in U.S. Pat. No. 5,425,508. However, many different kinds of refiners are in use today. For example, there are counter rotating refiners, double disk or twin refiners, and conical disk refiners. Conical disk refiners are often referred to in the industry as CD refiners.

Each refiner plate is typically made of a relatively hard material that has a refining surface comprised of upraised bars. During refiner operation, fibrous matter in the stock slurry passes through a refining zone between opposed refiner plates and is fibrillated by grinding, tearing, crushing and/or bursting the fibrous matter between bars of the opposed plates.

These plates are formed with a refining surface that is substantially flat or which forms part of a conic section where the refiner is a CD refiner. When assembled in a refiner, the opposed plates form a refining zone that is defined by a gap between the plates. The spacing between the plates is often adjusted prior to refiner operation so the refining zone has a particular desired gap that is chosen based on the refining application as well as, quite often, trial and error. There are even mechanisms that attempt to measure the gap during refiner operation to determine whether the gap is optimal for the refining application or whether the gap needs to be adjusted. In some instances, feedback from one or more gap sensors is used to adjust the distance between the plates during refiner operation to try to keep the gap as constant as possible.

Unfortunately, despite efforts to try to maintain as constant of a gap as possible, the gap is not necessarily uniform throughout the entire refining zone due to deflection that can occur to each refiner plate segment. As a result, it is desired to produce a segmented refiner plate that maintains a more uniform gap during refiner operation.

### SUMMARY OF THE INVENTION

The present invention is directed to a refiner plate segment and refiner plate that is constructed and arranged to compensate for and accommodate deflection that occurs during refiner operation. The present invention is also directed to a method of determining where such deflection occurs including its magnitude as well as a method of designing a deflection compensating refiner plate segment and refiner plate.

In one preferred embodiment, the refiner plate segment has a planar refining surface with a portion of the refining surface that is unsupported such that it defines an overhang. To compensate for deflection of the segment that occurs during refiner operation, at least a portion of the refining surface in the region of the overhang is offset, such as by reducing the thickness of at least a portion of the segment in that region. Preferably, where it has been determined that the refining surface in the region of the overhang deflects outwardly into the refining zone, the offset is an inward offset that displaces at least a portion of the refining surface in the region of the overhang inwardly and away from the refining zone relative to another portion of the refining surface. During refiner operation, as the centrifugal force on that portion of the refining surface in the region of the overhang increases, the offset portion of the refining surface deflects outwardly toward the refining zone relative to another portion of the refining surface a sufficient amount such that substantially the entire refining surface is planar. This is because centrifugal force urges the refining surface in the region of the overhang as well as the mass of that part of the segment that is disposed in the region of the overhang outwardly towards the refining zone. Such deflection compensation advantageously produces a more uniform refining gap throughout the entire refining zone, which reduces energy usage, increases throughput, and increases refined pulp quality.

In another preferred embodiment, the deflection compensating refiner plate segment has a pair of overhangs with one of the overhangs extending transversely in one direction and the other one of the overhangs extending transversely in an opposite direction. At least a portion of the refining surface in the region of the each overhang is offset to compensate for deflection that occurs during refiner operation. Where it has been determined or learned that deflection occurs in other regions of the refining surface, the refining surface can have additional deflection compensating regions that are offset. For example, where it has been determined that centrifugal force causes a middle region of the refining surface to deflect outwardly into the refining zone; the middle region of the refining surface can be formed with an inward offset to compensate for such deflection. In another instance, where it has been determined that there are one or more regions of inward deflection, the refining surface can be formed with an outward offset in each such region.

In another preferred embodiment, the deflection compensating refiner plate segment is a segment for a conical disk refiner that mounts to a rotor of the conical disk refiner. The segment has a front side with a refining surface that is defined by a plurality of pairs of upraised and spaced apart refiner bars. The backside of the segment includes a longitudinally extending mount that is constructed and arranged to be received in a plate holder of the conical disk refiner. In a preferred mount arrangement, the mount comprises a dovetail tenon that is received in a complementary mortise of the conical disk refiner. Such a mortise is shaped like a channel or slot that is open at one end for slidably receiving the dovetail tenon. When assembled, the dovetail tenon and the mortise form a dovetail joint that retains the segment in place during refiner operation.

The segment has at least one overhang and typically has a pair of overhangs with one overhang extending transversely outwardly of the mount in one direction and the other overhang extending transversely outwardly of the mount in another direction. Ideally, during refiner operation it is desired that the transverse cross-sectional contour of the refining surface conforms to a section of a circle and that the refining surface forms a segment of a conic section.

However, because of the unsupported mass of the segment that is disposed at and along each overhang, centrifugal force acting on this unsupported mass causes the segment in the region of each overhang to deflect outwardly toward the refining zone. As a result, at least a portion of the refining surface in the region of each overhang displaces outwardly during refiner operation toward the refining zone due to deflection.

To compensate for deflection, the deflection is first determined. More specifically, in a preferred method of determining deflection, the locations and magnitudes of refining surface deflection are determined by computer simulation. Preferably, finite element analysis is used to determine the magnitude and location of each region of refining surface deflection. To do so, a transverse cross-section of a segment is modeled by applying a mesh to it and a set of boundary conditions is defined before simulating the centrifugal force that the segment would likely experience during refiner operation. To simulate the centrifugal force that the segment likely experience during refiner operation, the segment is rotated about an axis of rotation at a rotational speed that it would experience during typical refiner operation. Preferably, where the segment is a segment for a conical disk refiner, the segment is rotated at a rotational speed of at least 1500 rpm.

In another preferred method of determining deflection, an actual segment is fitted with a plurality of pairs of refining gap sensors that are used to determine the gap along the refining surface during refiner operation. Preferably, a multitude of sensors are used with sensors distributed transversely along the refining surface to provide measurement of the refining gap along the transverse contour of the refining surface. The deflection is determined at each sensor location by determining the difference between the actual refining gap and the desired refining gap at that sensor location.

As a result of either method of deflection determination, the location and magnitude of deflection in each region of the refining surface is then used to determine where and how to compensate for deflection. The location and magnitude of each region of deflection is taken into account in designing the segment so that it imparts to the refining surface a desired cross-sectional contour during refiner operation despite any deflection that occurs. The location and magnitude of each region of deflection is taken into account by designing the segment with an offset in each region that preferably is proportional to the magnitude of deflection in that region. Preferably, the offset in each region is the same as the magnitude of the deflection in that region and typically varies in magnitude along the region.

In one preferred method, location and magnitude data for a number of regions of deflection are determined and can be graphically plotted, if desired. Using the determined deflection data, regression or curve fitting can be utilized to derive an equation that can be a linear equation or a polynomial equation that preferably can be a third order polynomial equation.

Such an equation can be used to determine the magnitude and location of deflection compensating offsets to be applied to a segment to compensate for deflection during refiner operation. Such an equation can also be used to determine a grinding specification used in grinding or otherwise machining portions of the refining surface of a segment to form deflection compensating offsets in the refining surface of that segment. Otherwise, the deflection data can be used to determine such a grinding specification and can be used to determine the magnitude and location of each deflection compensating offset.

Preferably, where offsets are ground or otherwise machined into the refining surface of a segment, each segment is individually or independently machined. Where an equation is employed in the design process, the equation can be used to make a mold pattern that is used to mold or cast a segment with integrally formed deflection compensating offsets.

Where the segment ideally is to have a planar refining surface during operation, the refining surface is formed with offsets relative to planar such that during operation the offset portions of the refining surface deflect to form a refining surface that is substantially planar. A preferred example of such a segment is a deflection-compensating segment for a flat disk refiner that is attached to a rotor of the refiner. Preferably, all of the segments of each refiner plate mounted to a rotor of a particular refiner are deflection-compensating segments. Preferably, each rotor of the refiner is equipped with deflection-compensating segments.

Where the segment ideally is to have a refining surface with a transverse cross-sectional contour that is a section of a circle, i.e., has a radius of curvature, the refining surface is formed with offsets relative to the section of the circle such that during operation, the offset portions of the refining surface deflect to produce a refining surface that has a cross-sectional contour that is a section of a circle with an acceptable desired radius of curvature. A preferred example of such a segment is a deflection-compensating segment for a conical disk refiner that is attached to a rotor of the refiner. Preferably, all of the segments of each refiner plate that is mounted to a rotor of the refiner are deflection-compensating segments. Preferably, each rotor of the refiner is equipped with deflection-compensating segments.

In one preferred embodiment of a deflection compensating refiner plate segment that uses a mount that extends outwardly from its backside, the mount is formed with a hollow that reduces the mass of the segment in the area of the mount, which reduces deflection of the refining surface in the region of the refining surface that overlies the mount. Where the segment is a segment for a conical disk refiner that uses a dovetail mounting arrangement, the mount is a dovetail tenon that extends outwardly from the backside of the segment and has a hollow to reduce mass of the segment to reduce the deflection of at least a portion of the refining surface that overlies dovetail tenon.

In its preferred embodiment, the dovetail tenon includes a pair of spaced apart and longitudinally extending legs that each extends outwardly from the backside of the segment. The hollow preferably is concave in shape and disposed between the legs. To help provide strength and structural rigidity, there is a plurality of transversely extending ribs disposed in the hollow. Preferably, each rib extends from one leg to the other leg. As a result of the reduction in mass along the midsection of the segment due to the hollow, deflection longitudinally along substantially the entire midsection of the segment is advantageously reduced.

Objects, features, and advantages of the present invention include one or more of the following: a segment that is formed to compensate for deflection to produce a more uniform refining gap throughout the entire refining zone between the segment and a segment of another refiner plate that is opposed thereto; a deflection-compensating segment with improved energy efficiency; a deflection-compensating segment having increased throughput; a deflection-compensating segment that provides improved pulp quality; a deflection-compensating segment that better refines pulp fiber; a deflection-compensating segment that optimizes effective refining surface area by minimizing undesirable refining surface deflection; a method of determining segment deflection and compensation therefor that is simple, reliable, accurate, economical, and easy to implement and use; a method of forming a deflection compensating refiner plate and segment therefor that is simple, reliable, economical, and easy to implement and use; a deflection compensating segment produced therefrom that is simple, flexible, reliable, and long lasting, and which is of economical manufacture and is easy to assemble, install, and use.

Other objects, features, and advantages of the present invention will become apparent to those skilled in the art from the detailed description and the accompanying drawings. It should be understood, however, that the detailed description and accompanying drawings, while indicating at least one preferred embodiment of the present invention, are given by way of illustration and not of limitation. Many changes and modifications may be made within the scope of the present invention without departing from the spirit thereof, and the invention includes all such modifications.

### BRIEF DESCRIPTION OF THE DRAWING

Preferred exemplary embodiments of the invention are illustrated in the accompanying drawings in which like reference numerals represent like parts throughout and in which:

FIG. 1 is a schematic view of an exemplary conical disk refiner;

FIG. 2 is a cross sectional view of second exemplary conical disk refiner;

FIG. 3 is a top plan view of a refiner plate;

FIG. 4A is a transverse cross sectional view of a prior art refiner plate segment taken long line 4-4 of FIG. 3;

FIG. 4B is a second transverse cross sectional view of a prior art refiner plate segment taken long the same line, line 4-4 of FIG. 3, depicting that the refining surface of the segment can have a more curved contour or profile;

FIG. 5 is a fragmentary perspective view of a portion of a refiner plate segment for a conical disk refiner depicting the locations and magnitudes of deflections of its refining surface that occurs during refiner operation in comparison to the location of the refining surface when the refiner is not operating (shown in phantom);

FIG. 6 is an enlarged fragmentary cross sectional view of the portion of the refiner plate segment shown in FIG. 5;

FIG. 7 is a fragmentary cross sectional view of a portion of a conical disk refiner depicting a plurality of prior art refiner plate segments in a static state when the refiner is not operating;

FIG. 8 is a fragmentary cross sectional view of the portion of the conical disk refiner shown in FIG. 7 depicting the plurality of prior art refiner plate segments in a dynamic state during operation of the refiner;

FIG. 9 depicts a transverse cross section of a segment of a refiner plate of a conical disk refiner modeled with mesh for finite element analysis of refiner plate segment deflection;

FIG. 10 depicts a transverse cross section of a segment of the refiner plate of a conical disk refiner having a refiner surface that carries a plurality of pairs of refiner gap sensors used to determine deflection during refiner operation;

FIG. 11 illustrates a transverse cross section of a segment of the refiner plate of a conical disk refiner showing the locations and magnitudes of refining surface deflection;

FIG. 12 illustrates a transverse cross section of a preferred embodiment of a segment of the refiner plate of a conical disk refiner showing regions of the refining surface that have been formed to compensate for deflection during refiner operation;

FIG. 13 illustrates a transverse cross section of a second preferred embodiment of a segment of the refiner plate of a conical disk refiner showing regions of the refining surface that have been formed to compensate for deflection during refiner operation;

FIG. 14 graphically illustrates the magnitude and location of refining surface deflection as a function of the distance from a center, centerline or symmetry plane of a segment of the refiner plate of a conical disk refiner;

FIG. 15 illustrates a longitudinal cross sectional view of a third preferred embodiment of a deflection compensating refiner plate segment;

FIG. 16 illustrates a rear plan view of the deflection compensating refiner plate segment of FIG. 15;

FIG. 17 illustrates a transverse cross sectional view of the deflection compensating refiner plate segment of FIG. 15;

FIG. 18 illustrates a second longitudinal cross sectional view of the deflection compensating refiner plate segment of FIG. 15;

FIG. 19 is a fragmentary cross sectional view of a portion of a conical disk refiner in a static state depicting a plurality of prior art refiner plate segments carried by the stator of the refiner and a plurality of deflection compensating refiner plate segments carried by a rotor of the refiner; and

FIG. 20 is a fragmentary cross sectional view of the portion of the conical disk refiner shown in FIG. 19 depicting the plurality of deflection compensating refiner plate segments in a dynamic state.

### DETAILED DESCRIPTION OF AT LEAST ONE PREFERRED EMBODIMENT

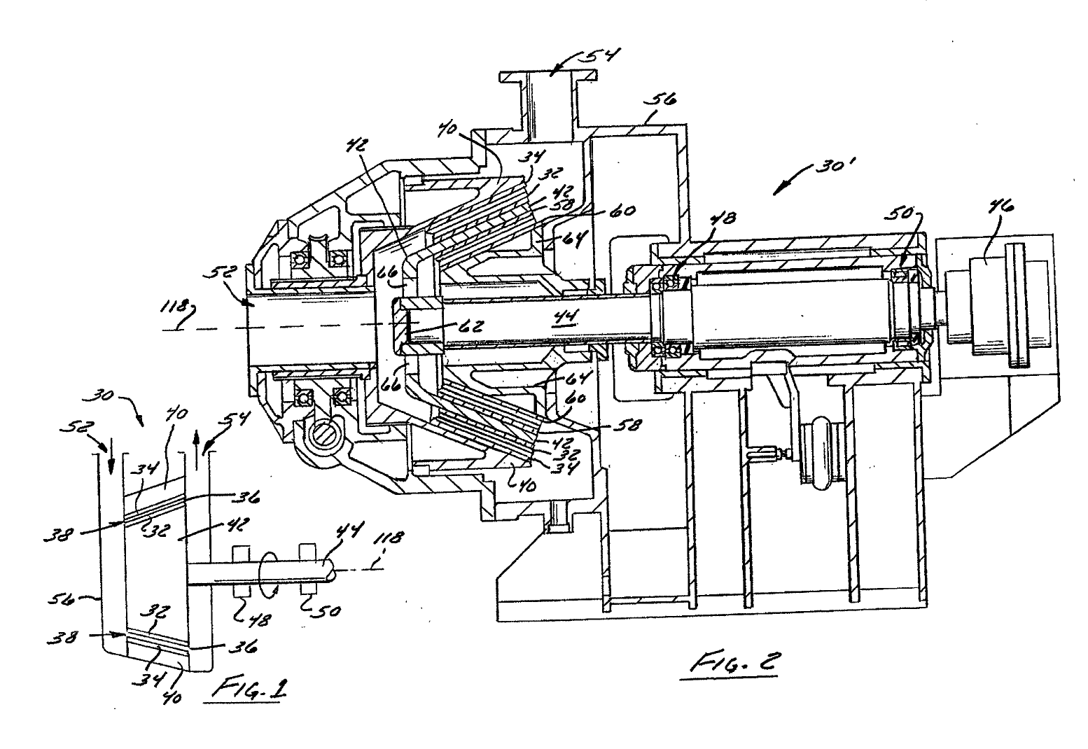

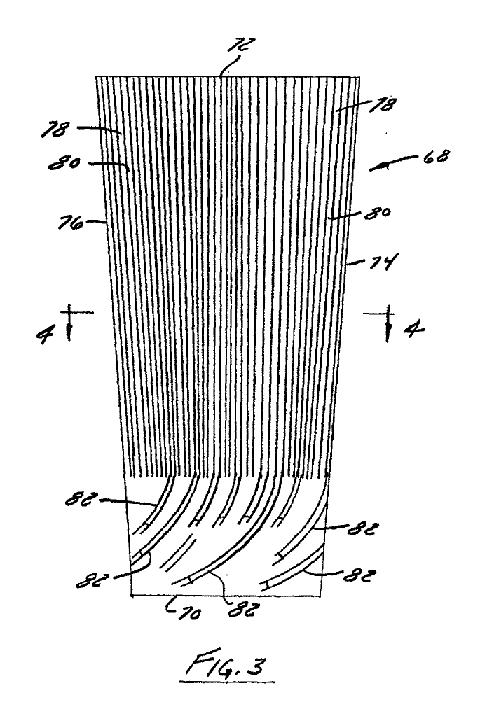

FIGS. 1 and 2 illustrates exemplary conical disk refiners 30 and 30′ equipped with a pair of conical disk refiner plates 32, 34, at least one of which has been constructed and arranged to compensate for deflection that occurs to the plate during operation of the refiner. As result, the gap 36 between the plates 32, 34 is more uniform along the entire refining zone 38 during the operation of the refiner 30. By keeping the gap 36 more constant throughout the refining zone 38 during refiner operation, energy consumption is reduced, refiner vibration and pulsations in flow are both reduced, and pulp quality is increased and is more consistent.

Referring to FIG. 1, the refiner 30 includes a stator 40 that carries refiner plate 34. The refiner 30 also has a rotor 42 that carries refiner plate 32. The rotor 42 is coupled to a shaft 44 that is driven by a prime mover (not shown) such as by a motor, through the use of steam, or by another means. For example, the refiner 30′ shown in FIG. 2 is driven by an electric motor 46. The shaft 44 is rotatively supported by a pair of spaced apart bearings 48, 50.

The refiner 30 has an inlet 52 through which stock to be refined enters the refiner. The rotor 42 rotates at a speed of between about 1500 rpm and about 2700 rpm thereby rotating refiner plate 32 at a like rotational speed. After passing between refiner plates 32, 34 the stock is expelled from the refiner out outlet 54. The inlet 52 and outlet 54 can be formed from part of the refiner housing 56, if desired. As the stock passes between the refiner plates 32, 34, fiber in the stock is refined, preferably by being fibrillated.

FIG. 2 illustrates a second exemplary conical disk refiner 30′. The refiner 30′ is similar to the refiner 30 schematically shown in FIG. 1 but includes two sets of conical refiner plates. One set of plates 32, 34 is disposed outwardly of the rotor 42 and a second set of plates 58, 60 is disposed inwardly of the rotor 42. The rotor 42 includes a cap 62 that can be constructed and arranged so as to permit some axial adjustment of the rotor 42 relative to stators 40, 64.

During operation of the refiner 30′ shown in FIG. 2, the rotor 42 is rotated, thereby rotating refiner plates 32 and 58. Stock enters through inlet 52 and is refined as it passes between plates 32 and 34. Some stock also passes through aperture 66 and travels between plates 58 and 60 where it also is refined. After being refined, the stock is discharged out outlet 54.

FIG. 3 illustrates a segment 68 of conical refiner plate 32 (or conical refiner plate 58). The refiner plate is made up of a plurality of such segments 68. Typically, the refiner plate is made up of a multiplicity of segments 68, that is, at least thirty segments. In at least one refiner plate configuration, each segment 68 encompasses an angular extent of about 10° but can encompass in angular extent of more or less than 10°.

Referring to FIG. 3, the segment 68 has an inner peripheral edge 70, an outer peripheral edge 72, a leading edge 74 that leads during rotation of the segment 68, a trailing edge 76 that trails during rotation of the segment 68, and a plurality of upraised refiner bars 78 that are spaced apart such that they define grooves 80 therebetween. The segment 68 can also be equipped with a plurality of spaced apart breaker bars 82 located near inner peripheral edge 70, if desired. If desired, one or more grooves can be equipped with one or more surface and/or subsurface dams (not shown). The pattern of refiner bars 78 shown in FIG. 3 is an exemplary bar pattern. If desired, other patterns can be used.

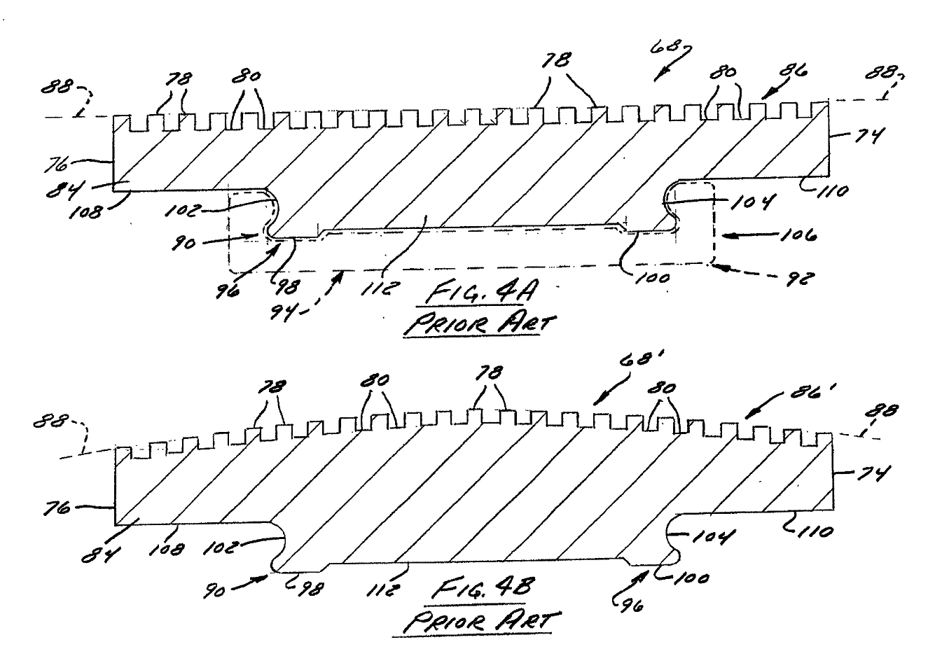

FIG. 4A depicts a transverse cross section of the conical refiner plate segment 68 shown in FIG. 3 taken along line 4-4. The segment 68 has a base 84 from which the refiner bars 78 outwardly or upwardly extend. As is shown in FIG. 4A, the base 84 and refiner bars 78 form a refining surface 86 that is curved such that its periphery forms a section of a circle. The periphery of the refining surface 86 can be approximated by a line 88 (in phantom) running tangent to the refining surface 86, which in this case is a line 88 that runs tangent to the tops of the refiner bars 78. While the transverse cross sectional periphery of the refining surface 86 appears generally flat or planar in FIG. 4A, such as is the case for a conical refiner plate that has a rather large diameter or for a flat disk refiner plate, it preferably is at least slightly curved. For the case of a flat disk refiner plate, the refining surface 86 will indeed be flat or planar. However, the refining surface 86 is generally flat or planar, like that depicted in FIG. 4A, where the refiner plate segment is a segment of a flat disk refiner (e.g., not a conical disk refiner).

A mount 90 projects outwardly from the backside of the base 84 and is used to removably attach the segment 68 to either the stator 40 or the rotor 42. The mount 90 is removably received in a plate holder 92 that is a receptacle that preferably is of complementary shape. Only part of the plate holder 92 in shown in phantom in FIG. 4A. The plate holder 92 extends outwardly from the rotor or stator to which the segment 68 is being attached. In its preferred embodiment, the mount 90 is a tenon and the plate holder 92 is a mortise 94. In its preferred embodiment, the tenon 90 comprises a dovetail 96 that includes a pair of outwardly disposed endwalls 98, 100 that each typically engage or bear against part of mortise 94. The dovetail 96 also includes a pair of sidewalls 102, 104 that each also typically engage or bear against some part of mortise 94.

In prior art segments, such as segment 68 and 68′ shown in FIGS. 4A and 4B, the mount 90 is solid 112 from sidewall 102 to sidewall 104 along the longitudinal length of the dovetail 96. Together the dovetail 96 and mortise 94 form a dovetail joint 106 (FIG. 4A) that retains the segment 68 in place during refiner operation.

As is shown in FIG. 4A, the mount 90 does not extend the full transverse width of the segment 68, which leaves a pair of overhangs 108, 110. Each overhang 108, 110 does not engage or bear directly against the stator or rotor 42 to which it is mounted. As a result, each overhang 108, 110 is unsupported and can deflect during refiner operation due to centrifugal forces and/or centripetal forces that the segment 68 experiences during operation. These forces can also cause the segment 68 to deflect in other locations.

FIG. 4B depicts another transverse cross section of the exemplary prior art conical refiner plate segment 68′ shown in FIG. 3 taken along line 4-4. The segment 68′ shown in FIG. 4B is very similar to the segment shown in FIG. 4A except that its refining surface 86′ has a radius of curvature that is greater than the radius of curvature of the segment 68 shown in FIG. 4B. Such is the case for conical refiner plates that have a relatively small diameter. The curvature of the periphery of the refining surface 86′ has been exaggerated for clarity and also comprises a section of a circle.

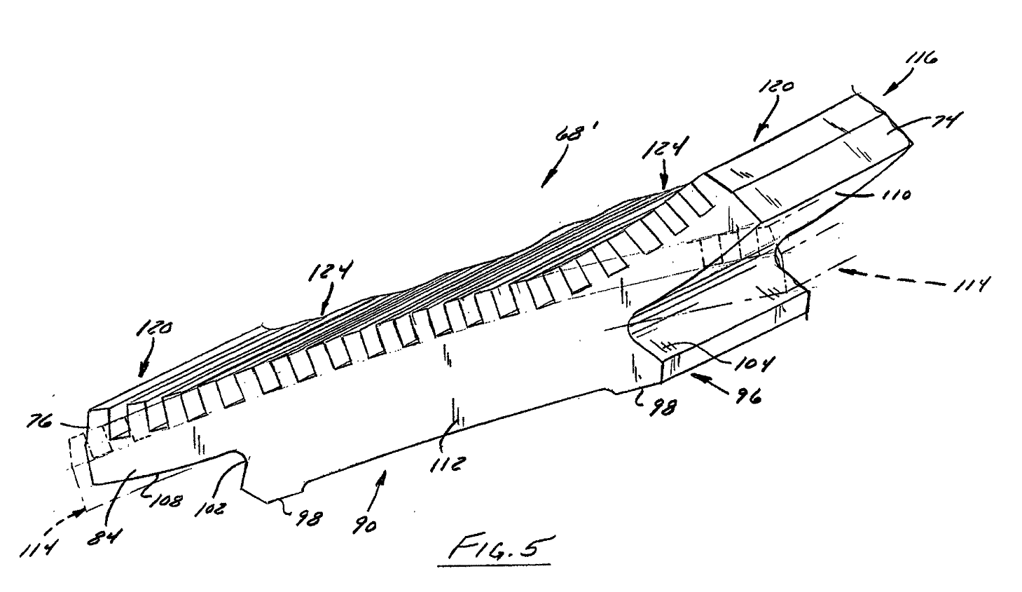

FIGS. 5 and 6 depict a portion of segment 68 in both its static or unloaded state 114 (shown in phantom) and its dynamic or loaded state 116 during refiner operation. The static state 114 is defined when the rotor 42 is not moving. The dynamic state 116 (shown in solid) is defined when the refiner 30 is operating under load (e.g., refining stock) and the rotor 42 is rotating at a minimum rotational speed of at least 1500 revolutions per minute (rpm).

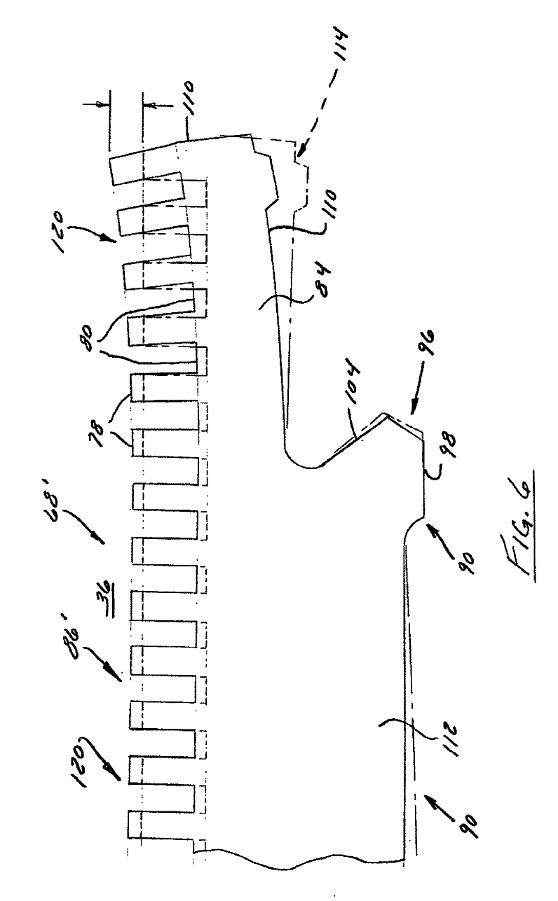

Ideally, is intended that the refining gap 36 be substantially constant throughout the refining zone 38 during refiner operation. FIG. 7 illustrates a portion of a conical disk refiner that has a plurality of conical disk refiner plate segments 68 (or 68′) mounted to a stator 40 to form one refiner plate and a plurality of segments 68 (or 68′) mounted a rotor 42 to form an opposing refiner plate. The gap 36 between the segments is substantially constant when the rotor 42 is not rotating because none of the segments are experiencing any deflection.

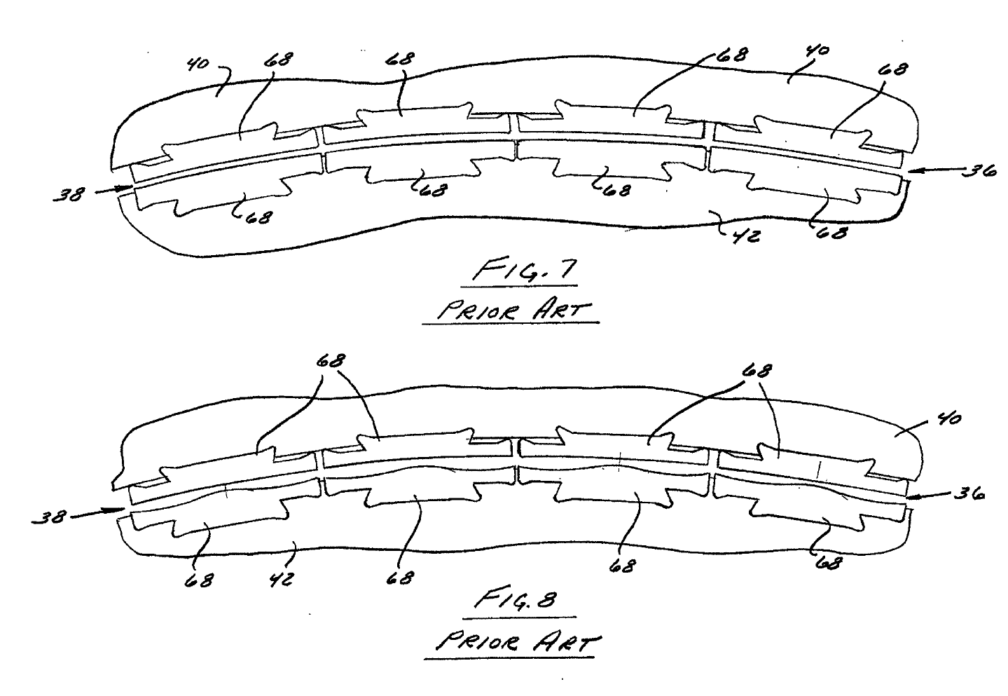

Referring to FIG. 8, during refiner operation, each segment 68 (or 68′) rotates about an axis of rotation 118 (FIGS. 1 and 2) at a rotational speed of between the minimum rotational speed and rotational speed of 2700 rpm. Typically, the rotational speed varies between a minimum rotation speed of 1800 rpm and 2700 rpm. In some other conical disk refiners and other refining applications the minimum rotational speed is about 1500 rpm.

In a conical refiner, each segment 68 is inclined at an angle relative to the axis of rotation. For example, each segment 68 is oriented such that its longitudinal axis is disposed at an angle of about 15° relative to a plane perpendicular to the axis of rotation. As a result of the orientation of each segment 68, each segment traces out a band of a cone such that it forms a conic section as it rotates. All of the segments 68 of a refiner plate form a conic section when assembled in a refiner.

As is depicted in FIG. 8, and illustrated in more detail in FIGS. 5 and 6, each segment 68 deflects during refiner operation, which in turn causes the refining gap 36 to vary along the refining zone 38. It has been determined that this deflection adversely affects refiner operation.

Through finite element analysis and observation it has been discovered that both overhangs 108, 110 deflect during refiner operation, which in turn also causes the refining surface 86 (or 86′) to deflect. Since the transverse cross section of each segment 68 (or 68′) is symmetrical or substantially symmetrical, only the deflection of the leading overhang 110 will be further discussed because both overhangs 108, 110 similarly deflect during refiner operation. Typically, however, the refining surface 86 (or 86′) in the region of the leading overhang 110 deflects more than the refining surface in the region of the trailing overhang 108.

During refiner operation, the overhangs 108, 110 deflect outwardly and into the refining zone 38 in a first region of deflection that is identified in FIGS. 5 and 6 by reference numeral 120. The amount of deflection in each of these regions 120 becomes significant at rotational speeds as low as 1500 rpm and increases with increasing rotational speed. Typically, deflection of each overhang occurs such that the refining surface 86 (or 86′) adjacent each segment edge 74, 76 deflects such that it is displaced in its dynamic state 116 at least about 2 thousandths of an inch (0.05 mm) outwardly into the refining zone 38 from where it was previously located when it was in the static state 114. Depending on the rotational speed, refining loading, the thickness and length of each overhang 108, 110, the stiffness imparted by the material from which the segment 68 (or 68′) is constructed, and other factors, the amount of deflection of the refining surface 86 (or 86′) adjacent each edge 74, 76 can be as much as 15 thousandths of an inch (0.38 mm) or more.

As is shown most clearly in FIGS. 5 and 6, the deflection of the refining surface 86′ of the segment 68′ in its dynamic state 116 in the region of overhang 110 decreases from a maximum, dₘₐₓ, of at least two thousandths of an inch in region 120 located at or very close to the leading edge 74 to a minimum at a location inboard of the edge 74 where it converges with its location in the static state 114 such that its deflection is essentially zero. Typically, it converges within 1 to 1½ inches (2.54 cm to 3.81 cm) of the edge 74.

While the decrease in the amount of deflection from edge 74 can be approximated as decreasing linearly with the distance from the edge, it also can be approximated by a spline that preferably is a third order equation. If desired, the decrease in deflection can also be modeled or approximated as decreasing generally parabolically. Deflection is at a minimum where the location of refining surface 86′ in the region of overhang 110 does not appreciably differ from its location in the static state 114.

Although not shown in FIG. 5, there can be a second region 122 (FIG. 11) of outward refining surface deflection located adjacent the middle of the segment 68′ that has a maximum deflection that is less than the maximum deflection of outer deflection regions 120. Where such a middle region 122 of deflection exists, it can vary from being almost negligible to as much as 10-15 thousandths of an inch (0.25-0.38 mm). The middle region 122 is located a distance inboard from outer regions 120 adjacent the middle of the segment 68′. As is shown in FIGS. 5 and 6, the middle region 122 of deflection overlies mount 90.

It has also been determined that there can be a region 124 of inward deflection between regions 120 and 122. More specifically, for the segment 68′ shown in FIG. 5, a region of slight inward deflection 124 occurs between the middle of the segment 68′ and leading edge 74. This region of inward deflection 124 is smaller in magnitude and deflects less, on the order of no more than about 2 thousandths of an inch (0.05 mm), than either region 120 of outward deflection. This region 124, to the extent such a region of inward deflection exists, generally overlies or is disposed adjacent one of the dovetail sidewalls 102,104. In at least some instances, the amount of deflection in this region 124 is virtually negligible if not completely nonexistent.

As a result of one or more of these deflections, the refining gap 36 is not uniform throughout the refining zone 38, which adversely impacts refiner operation. This is certainly true in the region 120 of deflection of the refining surface 86′ adjacent each overhang 108, 110. More specifically, the gap 36 is narrower than desired in the region of the refining surface 86′ that overlies each overhang 108, 110. This narrowing creates constrictions in the refining zone 38 adjacent each overhang that opposes the flow of stock. This can lead to pulsation in the flow of stock that is undesirable because it increases refiner vibration, which can adversely impact reliability, can reduce the rate of throughput of the stock, can decrease refiner efficiency, and can decrease the consistency of the quality of refining that is taking place. Additionally, deflection significantly reduces the total effective refining surface area of each segment 68 (or 68′), and hence the refiner plate 32, as well as the opposing plate 34, which can significantly decrease refining quality and refiner efficiency. As a result, conical disk refiner plates that have overhangs also have increased refiner energy usage due to these deflections. For example, it is believed that as much as 25% of the total refining surface is rendered ineffective because of refiner plate segment deflection during refiner operation.

To help ensure that the effect of deflection is minimized, the present invention forms the refining surface of the refiner plate such that deflection of the conical refiner plate segment while the refiner plate is under load is taken into account and compensated therefor. In a presently known best mode of carrying out the invention, only segments that form the refiner plate carried by the rotor are formed to compensate for deflection. In forming these deflection-compensation segments, the thickness of each segment is reduced in the region of each overhang such that the refining surface of each rotor-mounted segment adjacent the leading and trailing edges of the segment is disposed inwardly relative to a refining surface of a perfect conic section. Another preferred way of compensating for deflection, the refining surface of each rotor-mounted segment is offset relative to the refining surface of a perfect conic section. During operation, each segment deflects such that its refining surface forms a portion of a conic section instead of distorting away from such a section. As a result, the rotor-carried refiner plate formed by the segments deflects into a nearly perfect conic section during refiner operation, which dramatically increases the uniformity of the refining gap throughout the entire refining zone.

FIG. 9 illustrates an exemplary transverse cross-section of a segment 68′ (or 68) superimposed on an X-Y axis that can be used to help determine regions of outward and inward refining surface deflection. In one preferred method of determining the magnitude of the deflection in each region, finite element analysis is used. In performing finite element analysis, the segment 68′ is modeled such as by using a finite element modeler and a computer (not shown). Such a modeler is sometimes also called a mesher or preprocessor. In using the modeler, the transverse cross-sectional drawing of the segment 68′ being modeled is divided into a mesh 126 that can be a structured mesh or an unstructured mesh. An exemplary mesh 126 is depicted in FIG. 9.

A finite element analysis solver is then used to perform a computer simulation that subjects the modeled segment 68′ to the stresses and strains that it would likely encounter while under load and being rotated at a rotational speed of at least 1500 rpm. Preferably, a nonlinear solver is used. However, if desired, a linear solver can be used.

In setting up the solver, the following boundary conditions and loads are defined: the segment 68′ to be modeled is put in a modeled segment holder, such as the holder 92 depicted in FIG. 4A, that has sliding contact surface friction between the dovetail 96 and the holder 92, the density of the segment 68′ is taken into account, a grinding pressure is applied to tops of the refiner bars 78 of the segment 68′, and steam pressure in the refining zone is taken into account. For example, in one preferred method, the friction between the dovetail 96 and the refiner plate holder 92 is estimated to be about 0.2, the segment density is estimated to be about 7800 kg per cubic meter, and the steam pressure in the refining zone is estimated to be between 5-10 atmospheres for purposes of defining boundary conditions and loads. The segment 68′ is then rotated at a typical refiner operational speed. For example, in one preferred implementation of the method, the modeled segment 68′ is rotated at a rotational speed of at least 1500 rpm. If desired, an estimated grinding pressure can be calculated and included as a boundary condition/load. If desired, the grinding pressure need not be taken into account in most cases because it is thus far believed to have virtually no impact on refiner plate segment deflection.

The solver outputs a solution that approximates how the segment 68′ would behave when subjected to such loads and operating conditions that the segment 68′ would typically encounter during refiner operation. The solver is preferably a computer program run on a computer (not shown). The solution can then be analyzed by a postprocessor or the like run on a computer (not shown) that is capable of visually or graphically displaying a picture of the segment 68′ as it appears while under load during refiner operation. FIGS. 5 and 6 graphically depict exemplary results of such a solution for a transverse cross-sectional slice of a refiner plate segment 68′ taken a distance between each segment end 70, 72 (FIG. 3). In one preferred implementation of the method, the slice is taken adjacent the lengthwise middle of the segment 68′.

Preferably, at least a plurality of iterations is performed with increasingly finer mesh 126. For example, a coarse mesh can initially be used to get a rough idea of the locations and magnitudes of refiner plate deflections. The next iteration is then performed with a finer mesh and the deflections evaluated. To the extent needed, additional iterations are carried out with increasingly finer meshes until the magnitudes of the deflections do not appreciably vary such that there is a convergence.

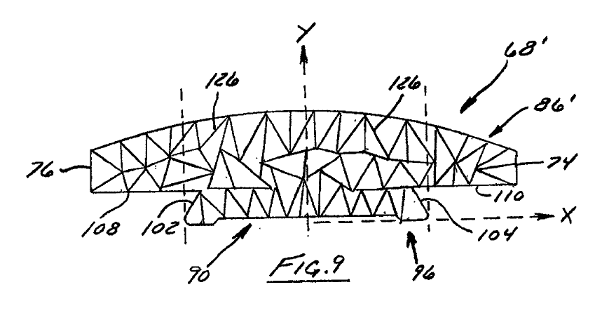

The regions of deflection can also be determined experimentally. Referring to FIG. 10, a transverse cross-section of a segment 68′ is fitted with a plurality of gap sensors 128 that are used to sense the refining gap 36 at various locations across the refining zone 38 during refiner operation. Preferably, the segment 68′ is equipped with a multiplicity of such sensors 128 that extend across the refining surface 86′ of the segment. For example, the segment 68′ shown in FIG. 10 has eighteen sensors 128 that are spaced apart transversely across the refining surface 86′ of the segment 68′. Preferably, the sensors 128 are equidistantly spaced apart. Although gap sensors 128 are the type that are embedded in the refining surface 86′ of the segment 68′ depicted in FIG. 10, other types of gap sensors, gap sensor locations, and gap sensing arrangements can be employed.

During operation, the deflection-sensing segment 68′ shown in FIG. 10 is rotated at a speed that preferably is at least 1500 rpm. As the segment 68′ rotates, each sensor 128 is monitored to determine the refining gap 36 in the region of each particular sensor 128. Each gap 36 measured is then compared against the ideal refining gap to which the refiner was intended or set to operate at. The difference between the measured gap 36 and the desired gap at each sensor 128 location represents the magnitude of segment deflection along the refining surface 86′ of the segment 68′. The magnitude of the deflections along the refining surface 86′ can then be taken into consideration to determine where deflection compensation is needed.

Referring to FIG. 11, whether determined analytically or measured experimentally, the deflections can be graphically represented or otherwise visually depicted. For example, regions 120, 122, and 124 of deflection are graphically represented in phantom in FIG. 11 (exaggerated for clarity). As is shown in FIG. 11, the magnitude of the deflections in each region vary depending on factors such as the cross-sectional thickness of the segment 68′, the unsupported distance from mount 90 (e.g., overhang), as well as the amount of mass in certain regions of the segment 68′. For example, it has unexpectedly been determined that the mass of the mount 90, as it is solid, contributes to or is responsible for outward deflection in the central region 122 of the refining surface 86′.

As previously mentioned, outward deflection of the refining surface 86′ (or 86) occurs along each overhang 108, 110. This means that during refiner operation, the refining surface 86′ along each overhang 108, 110 deflects outwardly into the refining zone 38 narrowing the refining gap 36 such that the gap 36 is less than desired in these regions. Still referring to FIG. 11, during refiner operation where the segment 68′ (or 68) is rotating at a rotational speed of at least 1500 rpm, the refining surface 86′ adjacent or at each outer edge 74, 76 deflects outwardly into the refining zone 38 an amount that typically is a maximum.

For example, where the segment 68′ (or 68) is a conical refiner plate segment, the refining surface 86′ (or 86) adjacent each segment edge 74, 76 deflects outwardly into the refining zone 38 a maximum amount, dₘₐₓ, of at least about 2 thousandths of an inch (0.05 mm) and typically no more than about 15 thousandths of an inch (0.38 mm). Typically, the region 120 of deflection adjacent each segment edge 74, 76 extends from the edge inwardly at least one inch (2.54 cm). Typically, the magnitude of deflection at a distance of about one-half the total transverse length of each deflection region 120 is between about 1 thousandth of an inch (0.025 mm) and about 10 thousandths of an inch (0.25 mm). The magnitude of the deflection in region 120 of the refining surface 86′ adjacent each segment edge 74, 76 decreases substantially parabolically or linearly. If desired, the magnitude of the deflection in each region 120 as a function of the distance from the center of the segment 86 (x=0) can be approximated by a function that is at least a second order function. In one preferred embodiment, the function is y=0.0008x³−0.0029x²−0.0018x+0.0047. In another preferred embodiment, the function is y=0.0007x³−0.0029x²−0.0014x+0.0068.

Another region 122 of outward deflection is located at or adjacent the transverse middle or midpoint of the refining surface 86′ (or 86). As previously discussed, the middle region 122 of outward deflection overlies mount 90. Is believed that the increased mass of the thicker center portion of the segment 68′ (or 68) and the mass contributed by the generally centrally located mount 90, which is solid between mount sidewalls 102, 104, produces increased centrifugal forces in this region. These increased forces cause the refining surface 86′ (or 86) in region 122 to deflect outwardly relative to those portions of the refining surface 86′ located on either side of region 122.

The middle region 122 of deflection has a maximum magnitude of deflection at or adjacent the centerline 130 of the segment 68′ (or 68). This maximum magnitude of deflection typically is no greater than 10-15 thousandths of an inch (0.25-0.38 mm) and typically is far less. As is shown in FIG. 11, the middle region 122 of deflection is curved, has a curvilinear periphery that is generally parabolic in shape, and extends longitudinally substantially the longitudinal length of the segment 68′ (or 68). Typically, deflection region 122 has a length of at least about 1-1.5 inches (2.54-3.81 cm) and extends in the ±x-direction at least about 0.5-0.75 inches (1.27-1.90 cm) from the centerline 130.

In some instances, the segment 68′ (or 68) can have one or more regions 124 of inward deflection. Where such a region 124 of inward deflection exists, it typically deflects inwardly at least about 1 thousandth of an inch (0.025 mm) and no more than about 3 thousandths of an inch (0.08 mm). As is shown in FIG. 11, where such a region or regions 124 of inward deflection exists, each region 124 is typically located at or adjacent an imaginary line 132 that divides each segment half into quarters. However, in many instances, the segment experiences no inward deflection whatsoever.

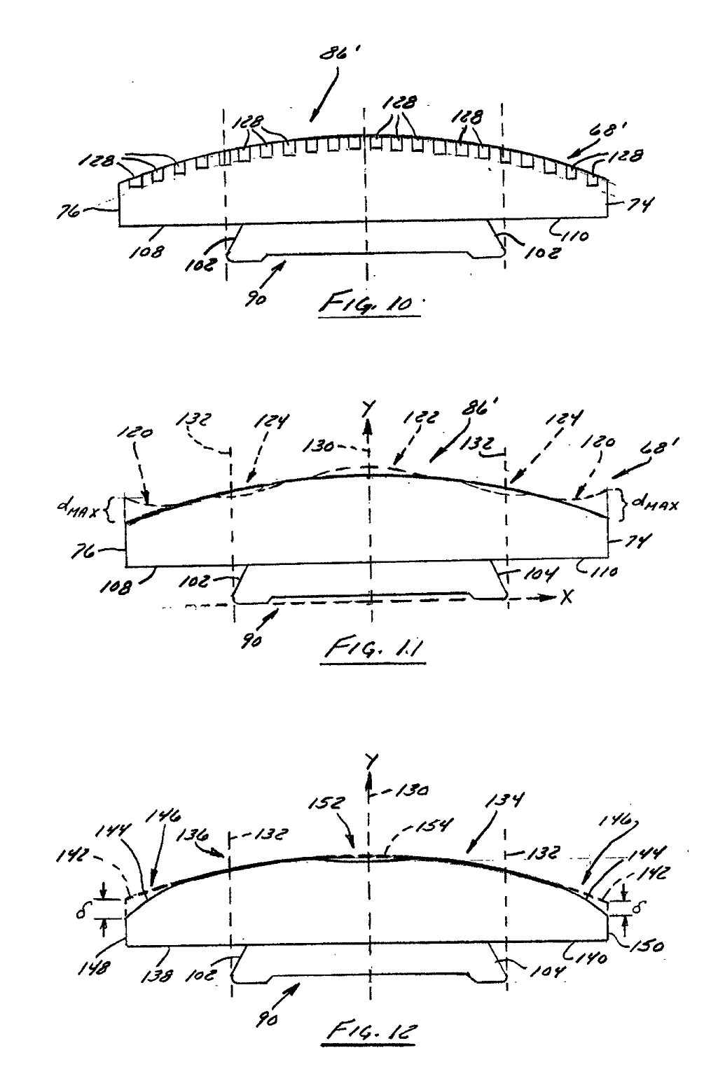

FIG. 12 illustrates a preferred embodiment of a segment 134 formed to compensate for deflection. The segment 134 is formed such that at least a portion of the refining surface 136 in the region that overlies both overhangs 138, 140 is recessed or offset relative to prior art segment 68 (or 68′) formed with a refining surface 86 (or 86′) shaped like a substantially perfect conic section in its static state. More specifically, the difference between the static state prior art refining surface shape, shown by curved phantom line 142, that was previously thought to be ideal during refiner operation, and the recessed or offset boundary 144 of the deflection compensating refining surface 136 in its static state. Phantom line 142 can also be characterized as being curved or being part of a circular section. This recessed or offset region, identified generally by reference numeral 146, is disposed adjacent each segment edge 148, 150. This deflection compensating region 146 is formed with less material adjacent each segment edge 148, 150 such that the thickness of the deflection compensating segment 134 is reduced adjacent each edge. The effect of reducing the thickness is to offset the boundary 144 of the actual refining surface 136 (in the static state) relative to the location 142 of the refining surface of prior art segment 68′ and/or 68 or the location 142 of a section of a circle having a desired or acceptable radius of curvature for the conic section formed by a refiner plate constructed of segments 134.

In one preferred embodiment, a region 146 of the refining surface 136 is inwardly offset from circular 142 along each overhang 138, 140 in the static state to compensate for deflection during refiner operation. During operation, centrifugal force acting on the segment 134 causes the refining surface 136 at and/or adjacent each region 146 to deflect upwardly toward phantom line 142. Preferably, the offset applied at and/or adjacent each region 146 results in each region 146 deflecting upwardly during refiner operation a sufficient amount such that its outer contour or profile matches that of phantom line 142. Preferably, the applied offset results in the boundary 144 of the refining surface 136 adjacent each end deflecting sufficiently upwardly such that its transverse cross-sectional profile or contour substantially conforms to a section of a circle or to the circular periphery of an ideal conic section.

In another preferred embodiment, the segment 134 can also have a region 152 of the refining surface 136 adjacent its middle that is also inwardly offset from circular in its static state to compensate for deflection. Similarly, during refiner operation the middle portion deflects outwardly toward phantom line 154, which represents the curved contour of the prior art refining surface 86′ (or 86). Phantom line 154 can also be characterized as being curved, circular, or being part of a circular section.

The outer deflection compensating regions 146 extend at least one half the longitudinal length of the segment 134 and preferably extend longitudinally the length of the segment or substantially the longitudinal length of the segment 134. Where a segment 134 also has a middle deflection compensating region 152, that region 152 also extends at least one half the longitudinal length of the segment 134 and preferably extends longitudinally the length of the segment 134 or substantially the longitudinal length of the segment 134.

Preferably, the amount the segment thickness is reduced and/or the amount of refining surface offset applied is proportional to the amount of deflection that a previously thought to be ideal prior art segment 68 or 68′ experiences or would experience during refiner operation under load. For example, where the segment 134 is a segment that forms a part of a conical disk refiner plate, the thickness is reduced by a distance, δ, of at least about 2 thousandths of an inch (0.05 mm) and no more than about 15 thousandths of an inch (0.38 mm) along the outside edge 148, 150 of the segment 134.

As is shown in FIG. 12, this region 146 of reduced thickness (or offset) decreases until the refining surface 136 converges with that of a section of a circle, such as what is the case for a refining surface 86′ (or 86) of the previously thought to be theoretically ideal segment 68′ (or 68). This region 146 of reduced thickness or offset has a boundary 144 that is curved. The shape or cross-sectional contour of the boundary 144 can be approximated as being parabolic. The thickness or offset decreases along the boundary 144 inboard of the corresponding outside segment edge 148 or 150 until the boundary 144 converges with phantom line 142, e.g., converges with that of a circular section. For example, the thickness or offset lessens to between about 1 thousandth of an inch (0.025 mm) and about 10 thousandths of an inch (0.25 mm) at a point that is located about halfway between the segment edge 148, 150 and the location where the boundary 144 converges with phantom line 142.

As is also shown in FIG. 12, the segment thickness can be selectively reduced or the offset selectively increased such that, for example, the refining surface 136 is selectively offset inwardly relative to phantom line 142. For example, where the segment 134 is a segment of a conical refiner plate, the refining surface 136 is selectively offset relative to circular 142 in the region 146 of each overhang 138 and 140.

FIG. 13 depicts another preferred embodiment of a refiner plate segment 134′ that has at least one region 156 of its refining surface 136′ disposed between regions 146 and 152 that is offset outwardly to compensate for inward deflection of the refining surface 136′ in the region 156. In the preferred embodiment shown in FIG. 13, the segment 134′ has a pair of outwardly bulging and spaced apart deflection compensating regions 156 that both extend outwardly beyond phantom line 142. Where such deflection compensation is implemented, each region 156 has a minimum offset of at least 1 thousandth of an inch (0.025 mm) at its point of maximum amplitude (i.e., where the bulged region is highest) and has a width of at least about ¼ inch or more.

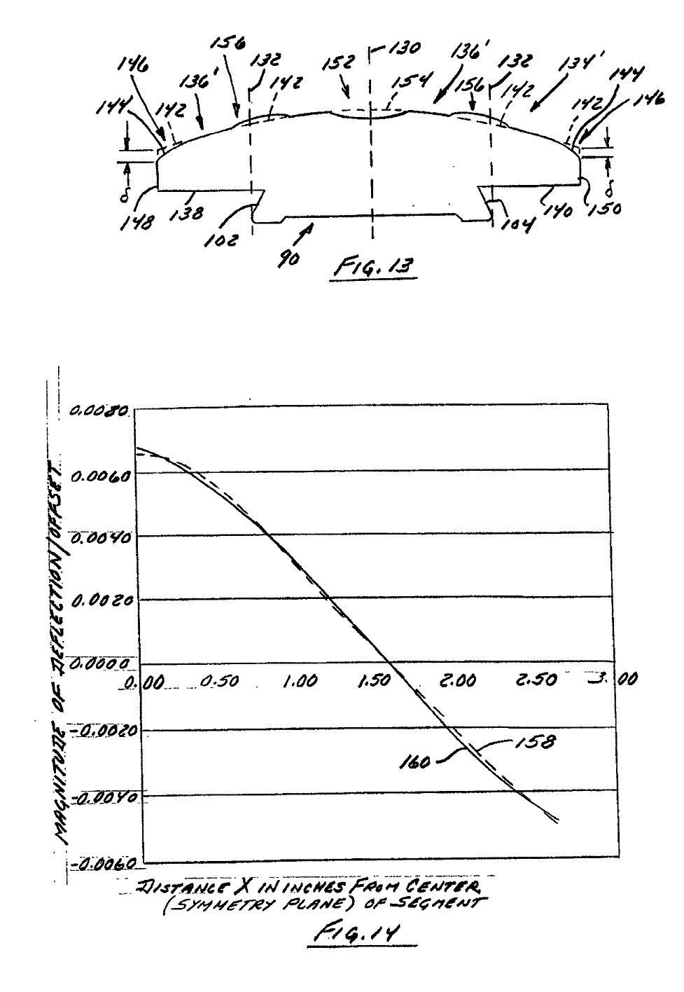

FIG. 14 illustrates one preferred implementation of how a plot 158 can be used in designing a deflection compensating conical refiner plate segment, such as segment 134 or 134′ (FIGS. 12 and 13). The plot 158 depicts the deflection that one half of the segment experiences during refiner operation along the transverse width of the half segment from the symmetry plane 130 (FIG. 12) of the segment or segment centerline 130 to the trailing edge 148 or leading edge 150 of the segment. It can be assumed for the purposes of design that the deflection is the same for both segment halves. As previously discussed, the leading half of the segment can experience more deflection than the trailing half because it typically experiences greater centrifugal force during refiner operation. However, the differences in deflection between the leading and trailing segment halves are typically so small such that in many instances the differences can practically be ignored.

Such a plot 158 can be determined analytically or experimentally by measuring or estimating the deflection of one segment half, such as in the manner discussed above, at a number of points along the refining surface of the segment half. After the deflections are plotted, regression, such as linear regression, or a polynomial curve fitting technique can be applied to determine an equation that fits the plot. For instance, for the plot 158 shown in FIG. 14, a polynomial curve 160 fit to the plot, e.g., polynomial curve fitting, was used to determine the polynomial y=0.0007x³−0.0029x²−0.0014x+0.0068 that can be used to predict the magnitude of deflection as a function of the distance from the symmetry plane of the segment. The variable y represents the magnitude of the deflection and the variable x represents the distance from the segment midpoint or symmetry plane 130 (e.g., FIGS. 11 and 12). The polynomial equation can be fit to data instead of a plot.

Deflection in the overhang region of each segment half can also be approximated as being linear. For example, the portion of the plot 158 disposed below the Y-axis shown in FIG. 14 indicates that the segment begins to deflect outwardly into the refining zone at a distance of slightly more than 1.5 inches from the symmetry plane or midpoint of the segment. As is shown by the plot 158, deflection of the refining surface increases substantially linearly further outwardly from the symmetry plane. More specifically, the deflection in this region 120 or 146 (FIGS. 11 and 12) of the refining surface can be approximated as being within ±5% of the deflection versus distance along the refining surface as determined using the equation y=−0.0048x+0.0075, where y is the magnitude of the deflection and x is the distance from the symmetry plane or midpoint. The line equation can be fit to data instead of a plot.

A plot, such as plot 158, can also be used as an offset determination plot to determine where and how much offset to apply to the refining surface of the deflection compensating segment 134 or 134′ (FIGS. 12 and 13) to compensate for deflection during refiner operation. Because offset is proportional to deflection, the magnitude and location of the offset applied is the same as or proportional to the deflection shown in the plot 158 in FIG. 14. Additionally, a polynomial determined through curve fitting, such as the polynomial equation y=0.0007x³−0.0029x²−0.0014x+0.0068 previously presented above, can also be used to determine the magnitude and location of the offsets to be applied in forming a refining surface that compensate for deflection during refiner operation such that the refining surface is circular or substantially circular in transverse cross-section. Likewise, an equation of a line, such as the line equation presented above, can also be used to determine the magnitude and location of the offsets to be applied. The variable y in the above equation represents the magnitude of the offset to be applied (or reduction(s) in segment cross-sectional thickness) and the variable x represents the distance from the segment midpoint or symmetry plane 130 (e.g., FIGS. 11 and 12). If desired, the actual offset applied (or reduction in segment cross-sectional thickness) can vary as much as ±5% from the value y that is calculated using this equation.

In another preferred method of determining the magnitude and location of offsets to be applied (or reduction(s) in segment cross-sectional thickness) adjacent each overhang region 146, the equation y=−0.0048x+0.0075 can be used to determine such offsets. If desired, the actual offset applied (or reduction in segment cross-sectional thickness) can vary as much as ±5% from the value y that is calculated using this equation. The variable y in the above equation represents the magnitude of the offset to be applied (or reduction(s) in segment cross-sectional thickness) and the variable x represents the distance from the segment midpoint or symmetry plane 130 (e.g., FIGS. 11 and 12).

In one preferred method of designing a deflection compensating refiner plate segment 134 or 134′, the offsets determined using either of the above equations or any of the above recited methods are used to produce a grinding specification that is used in determining where the segment is to be formed to compensate for deflection. If desired, the offsets can be determined for a single transverse cross-sectional slice of segment 134 or 134′ and used in producing a single grinding specification that is used substantially throughout the entire longitudinal length of the segment (if not the entire longitudinal length of the segment). If desired, offsets can be determined for multiple transverse cross-sectional slices of segment 134 or 134′ and a separate grinding specification can be produced for each slice such that a three-dimensional grinding map is produced. In one preferred method of making a deflection compensating refiner plate segment 134 or 134′, forming of the refining surface to compensate for deflection is accomplished by machining, preferably using a CNC machine tool, such as a grinder or the like. The grinding specification produced with the deflection compensating offsets, e.g., thickness reductions, produces a table of numbers that is programmed or otherwise inputted into a computer or processor of a numerically controlled machine tool that performs the machining to make the deflection compensating refiner plate segment 134 or 134′. Each deflection compensating refiner plate segment 134 or 134′ of a particular refiner plate preferably is individually machined as opposed to being first assembled to form the refiner plate and then machined substantially in unison while so assembled, as was previously done in the prior art.

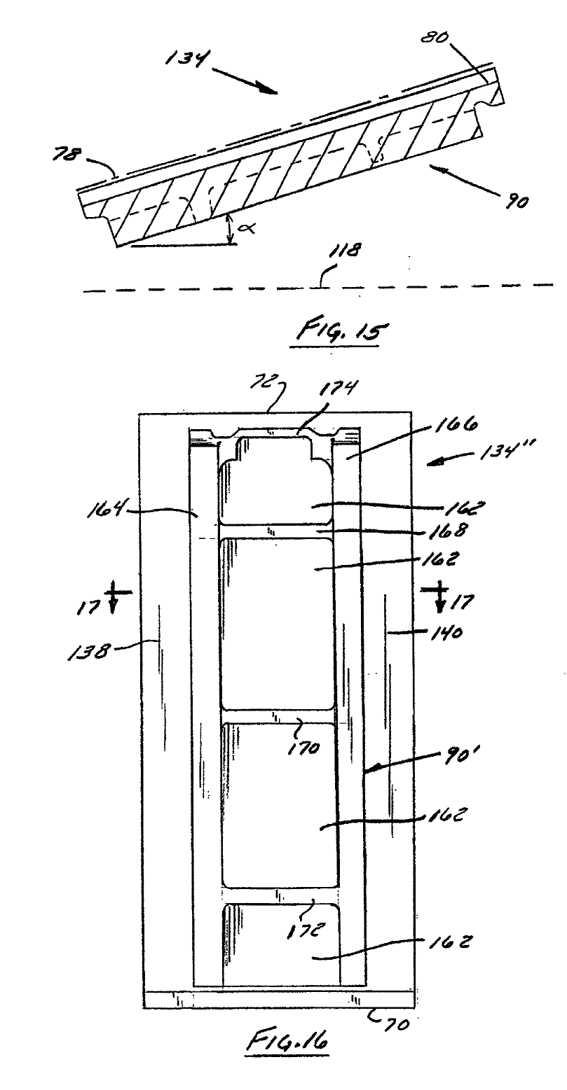

FIG. 15 illustrates a deflection-compensating segment 134 (or 134′) of a conical refiner plate disposed at an angle, α, of about fifteen degrees relative to horizontal, such as what the segment 134 would typically be oriented during refiner operation. For example, the segment 134 shown in FIG. 15 is disposed at an angle, α, of fifteen degrees relative to the axis of rotation 118 of the segment.

In one preferred method of forming a deflection-compensating segment 134 (or 134′) of this invention, the segment 134 is disposed as shown in FIG. 15 and machined in this orientation using a grinding specification determined using previously determined deflection compensating offsets. In contrast with prior art practices where all segments of a conical refiner plate were assembled into a conical refiner plate and machined substantially in unison, each deflection-compensating segment 134 (or 134′) of a conical disk refiner plate is individually machined. Preferably, each deflection-compensating segment 134 (or 134′) is machined without first being assembled into the form of a conical disk refiner plate.

The above methods can also be employed to design and make a deflection compensating refiner disk segment for a flat disk refiner. Preferably, each such segment can be individually machined in the manner described above. More specifically, deflection-compensating offsets are individually machined into each flat plate refiner segment using the deflection information determined using one or more of the above discussed techniques. Preferably, the offsets are also used to provide a grinding specification that is programmed or otherwise inputted into a numerically controlled machine tool. The deflection compensating offsets determined reduce or increase the thickness of the segment such that the refining surface deviates from planar along some part of the refining surface in select portions of the refining surface where it has been determined that deflection compensation is needed.

In another preferred method of forming a deflection-compensating segment of this invention, each segment of a conical disk refiner plate or a flat disk refiner plate is cast such that the deflection compensating offsets are integrally formed in the refining surface of the cast segment. If necessary, the refining surface can be machined as a final finishing step. For example, as a result of some imprecision in the casting process, it may be necessary to machine off a portion of some of the tops of some of the refiner bars to provide the proper deflection-compensating offset.

FIGS. 16-18 illustrate a preferred embodiment of a deflection compensating conical disk refiner plate segment 134″ that provides deflection compensation through removal of material in its mount 90′. As result of having less material, the mount 90′ has less mass, which means that less centrifugal force acts on the center for middle of the segment 134″. As a result, there is less deflection in the center or middle of the segment along the longitudinal length of the segment 134″. Such a deflection compensating arrangement can be used alone or in combination with one or more of the other deflection compensating methods discussed above. However, in one preferred embodiment of the segment 134″, the refining surface in the region of each overhang 108, 110 is also inwardly offset, such as in the manner depicted in FIGS. 12 and 13, relative to a segment of a circle to compensate for deflection during refiner operation.

FIG. 16 illustrates the backside of the segment 134″. In its preferred embodiment, the mount 90′ is a tenon that is hollow 162 so as to reduce the amount of mass that the segment 134″ has along its middle or longitudinal centerline. The tenon 90′ includes a pair of longitudinally extending legs 164, 166 that extend substantially the longitudinal length of the segment. In the preferred segment embodiment shown in FIG. 16, the top of each leg 164, 166 terminates inwardly of the top edge 72 of the refining surface and the bottom of each leg 164, 166 terminates inwardly of the bottom edge 70 of the refining surface.

To limit flexing of the legs 164, 166 during refiner operation, the tenon 90′ includes a plurality of longitudinally spaced apart transversely extending ribs 168, 170, 172 that each preferably extend from one tenon leg 164 to the other tenon leg 166. In the preferred segment embodiment shown in FIG. 16, there are three spaced apart transversely extending ribs 168, 170, 172. There can be an additional rib 174 that extends from the top of one tenon leg 164 to the top of the other tenon leg 166 and an additional rib (not shown) that extends from the bottom of one tenon leg 164 to the bottom of the other tenon leg 166, such as where it is desired to impart additional stiffness.

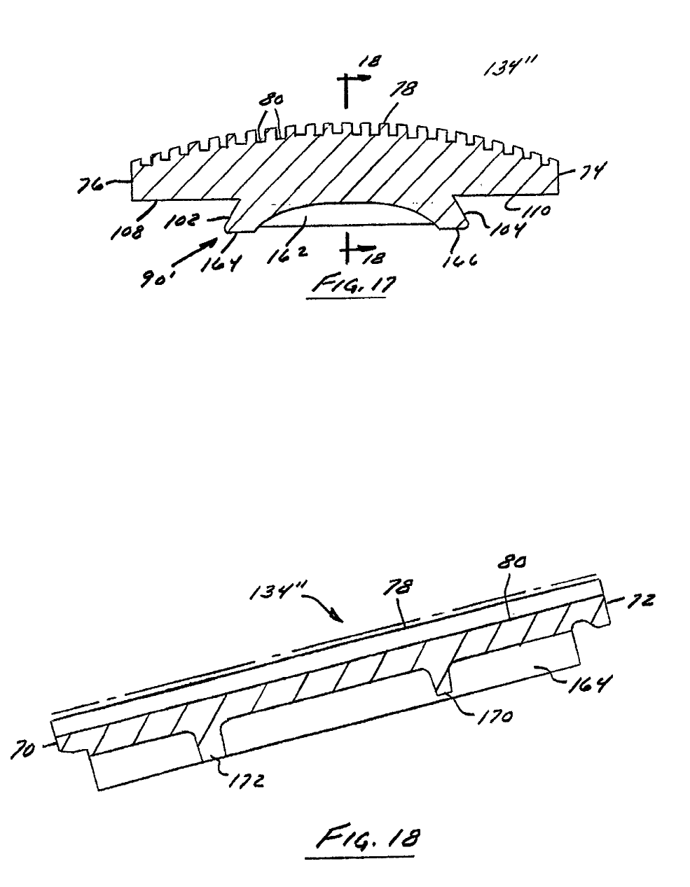

Referring additionally to FIG. 17, the preferred embodiment of the tenon 90′ has a concave cross-sectional construction. Such a construction provides smooth positively angled contours that enables the tenon 90′ to be integrally cast with the rest of the segment 134″. Such a construction is also advantageous because it requires little or no machining of any rib 168, 170, 172, 174 and preferably also requires little or no machining in the concave region 162 between tenon legs 164, 166.

Depending on the casting process utilized, little or no machining of the entire tenon 90′ may be needed. However, it is currently contemplated that the bottom of each tenon leg 164, 166 and the outer side 102, 104 of each tenon leg will need to be machined at least somewhat to help ensure a snug or tight fit between the tenon 90′ and the refiner plate segment holder 92 (e.g., mortise 94), such as the holder 92 shown in FIG. 4A, in which the segment is to be received.

FIG. 18 illustrates another preferred embodiment of segment 134″. As is shown in FIG. 18, the segment 134″ can be constructed with just a pair of reinforcing ribs 170, 172 with the bottom rib 172 being thicker and extending further outwardly from the backside of the segment 134″ than the rib 170 disposed outwardly or outwardly of it. Rib 172 can be larger to provide more strength and structural rigidity.

Referring once again to FIG. 1, deflection compensating refiner plate segments 134 of this invention are attached to the rotor 42 such that preferably each and every segment 134 attached to the rotor 42 is a deflection-compensating segment. When attached to the rotor 42, the deflection compensating segments 134 form a refiner plate 32. In the case of the refiners 30, 30′ shown in FIGS. 1 and 2, the assembled deflection compensating segments 134 form a refiner plate 32 that a shaped like a conic section or a band thereof. Where deflection-compensating segments are used in a flat disk refiner (not shown), the assembled segments form an annular refiner plate that typically has a refining surface that is flat and disposed generally perpendicular to the axis of refiner plate rotation.

In use, deflection-compensating segments 134 are used in refiners that process fiber entrained in a stock slurry that is comprised of a liquid that typically is water. The entrained fiber can comprise wood, cellulose, lignocellulose, fabric, and/or any other type of fiber used in making paper, paper fiber, or paper related products.

In operation, stock containing fiber travels between pairs of opposed refiner plates 32, 34 of the refiner 30 shown in FIG. 1 (or FIG. 2) where refiner bars 78 of the plates fibrillate them, such as by grinding them, mashing them, and/or tearing them, in preparation for further processing as part of a fiber product manufacturing process.

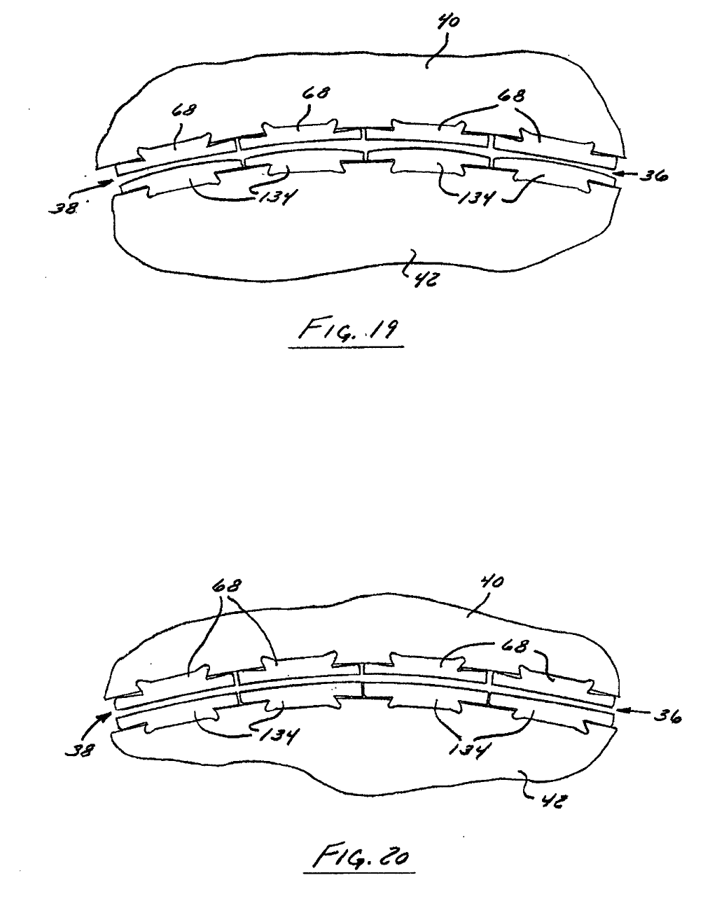

For example, FIG. 19 illustrates an exemplary conical disk refiner in its static state that has a plurality of pairs of conventional refiner plate segments 68 mounted to its stator 40 and a plurality of pairs of deflection compensating refiner plate segments 134 mounted to its rotor 42. Each conventional segment 68 has a refining surface that defines a cross-sectional contour that is a section of a circle, i.e. has a radius of curvature. Each conventional segment 68 does not need to have any region offset to compensate for deflection during refiner operation because each segment 68 is mounted to the stator 40, which does not move during operation, and therefore each segment 68 does not deflect or does not deflect enough to warrant deflection compensation.

In contrast, each deflection compensating refiner plate segment 134 has a plurality of spaced apart regions that deviate from the section of the circle to which the refining surface of the conventional segment conforms. Referring once again to FIG. 12, each segment 134 has a plurality of spaced apart regions 146 that are each offset relative to the section of the circle to which the refining surface of the conventional segment conforms. Depending upon the construction and arrangement of the segment 134, including its mount 90 or 90′, the segment 134 can be constructed with a deflection compensating offset region 152 adjacent a centerline 130 or symmetry plane 130 of the segment. If needed, the segment can be constructed similar to or the same as segment 134′ shown in FIG. 13 (or segment 134″ shown in FIGS. 16-18). Such a segment has additional deflection compensating regions 156 that compensate for inward deflection of the refining surface.

FIG. 20 depicts the refiner in a dynamic state. During operation, the rotor 42 rotates causing each deflection compensating refiner plate segment 134 also to rotate. As the rotational speed increases, each deflection compensation region begins to deflect. For example, where each segment 134 is equipped with a pair of spaced apart deflection compensation regions 146 (FIG. 12) that is each inwardly offset relative to the rest of the refining surface, each of these regions 146 begins to deflect outwardly into the refining zone 38. At a rotational speed of at least 1500 rpm, each deflection-compensating region, such as region(s) 146, 152 and/or 156, of each segment 134 (or 134′, 134″) deflects a sufficient magnitude or amount such that the transverse cross-sectional contour of substantially the entire refining surface conforms to that of a section of a circle. Preferably, the refining surface of each segment 134 (or 134′, 134″) has a radius of curvature that is the same as or substantially the same as the radius of curvature of segment 68 once the rotor 42 reaches an operational speed that is at least 1500 rpm.

As a result of the refiner plate 32 attached to the rotor being a deflection compensating refiner plate that is comprised of deflection compensating segments 134, the refining gap 36 between the deflection compensating refiner plate 32 and the opposed refiner plate 34 attached to the stator 40 is more uniform. More specifically, the refining gap 36 is more uniform from the leading edge to the trailing edge of each segment 134 and from the radially inner edge to the radially outer edge of each segment 134.

Improved gap uniformity results in decreased energy usage. For example, tests of deflection compensating conical refiner plate segments 134 have shown a decrease in energy usage of at least five percent. More specifically, testing of deflection compensating conical refiner plate segments 134 have shown a decrease in energy usage of about 12 percent, which is a significant decrease in energy.

Increased gap uniformity also advantageously improves refining quality. This is because a more uniform refining gap 36 means that more of the refining surface of each segment is actually being utilized to refine fiber during refiner operation.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

What is claimed is:

1. A rotary disk refiner for refining fiber in a liquid stock comprising:
a housing having a stock inlet;
a rotor within the housing that rotates about an axis of rotation during operation and which has a first refiner plate mounting surface;
a second refiner plate mounting surface within the housing that opposes the rotor;
a first refiner plate carried by the first refiner plate mounting surface, the first refiner plate comprised of a plurality of pairs of upraised refiner bars that define grooves therebetween that collectively form a first refining surface;
a second refiner plate carried by the second refiner plate mounting surface, the second refiner plate comprised of a plurality of pairs of upraised refiner bars that define grooves therebetween that collectively form a second refining surface, wherein the second refiner plate opposes and is spaced from the first refiner plate, and wherein a refining zone is defined between the opposed refining surfaces of the first and second refiner plates; and
wherein one of the refiner plates is comprised of a plurality of refiner plate segments, with at least one of the refiner plate segments being a deflection compensating refiner plate segment that has a refining surface with a portion of the refining surface offset to compensate for deflection of the deflection compensating refiner plate segment during operation of the rotary disk refiner.

2. The rotary disk refiner of claim 1 wherein the deflection compensating refiner plate segment has an overhang disposed rearwardly of the portion of its refining surface that is offset to compensate for deflection of the deflection compensating refiner plate segment during operation of the rotary disk refiner.

3. The rotary disk refiner of claim 2 wherein the portion of the refining surface that is offset to compensate for deflection of the deflection compensating refiner plate segment during operation of the rotary disk refiner is inwardly offset relative to another portion of the refining surface of the deflection compensating refiner plate segment.

4. The rotary disk refiner of claim 3 wherein the thickness of the deflection compensating refiner plate segment is reduced in the portion that is offset such that the offset portion is inwardly offset.

5. The rotary disk refiner of claim 2 wherein the portion of the refining surface that is offset to compensate for deflection of the deflection compensating refiner plate segment during operation of the rotary disk refiner is outwardly offset relative to another portion of the refining surface of the deflection compensating refiner plate segment.

6. The rotary disk refiner of claim 5 wherein the thickness of the deflection compensating refiner plate segment is increased in the portion that is offset such that the offset portion is outwardly offset.

7. The rotary disk refiner of claim 1 wherein the refining surface of the deflection compensating refiner plate segment is disposed on a front side of the deflection compensating refiner plate segment and a mount is disposed on a backside of the deflection compensating refiner plate segment, the mount defining a pair of spaced apart overhangs on the deflection compensating refiner plate segment with one of the overhangs disposed along one side of the mount and another one of the overhangs disposed along the other side of the mount, and wherein there are a plurality of spaced apart portions of the refining surface that are offset to compensate for deflection of the deflection compensating refiner plate segment with the offset portions of the refining surface including a first pair of offset portions with one of the first pair of offset portions being disposed in a part of the refining surface that overlies one of the overhangs and the other one of the first pair of offset portions being disposed in another part of the refining surface that overlies the other one of the overhangs, and wherein each one of the offset portions of the first pair of offset portions is inwardly offset to compensate for deflection that occurs to the deflection compensating refiner plate segment during operation of the rotary disk refiner.

8. The rotary disk refiner of claim 7 wherein the mount comprises a dovetail tenon that is received in a refiner plate holder of the rotary disk refiner that comprises a mortise.

9. The rotary disk refiner of claim 8 wherein the dovetail tenon comprises a pair of spaced apart and longitudinally extending legs that define a hollow therebetween that reduces the mass of the deflection compensating refiner plate segment such that outward deflection along a middle portion of the refining surface is reduced.

10. The rotary disk refiner of claim 9 further comprising a pair of transversely extending and spaced apart ribs that each extend from one of the legs to the other one of the legs of the dovetail tenon.

11. The rotary disk refiner of claim 9 wherein the hollow disposed between the legs of the dovetail tenon has a concave shape.

12. The rotary disk refiner of claim 7 wherein the plurality of spaced apart portions of the refining surface that are offset includes a second offset portion of the refining surface (1) that is spaced from the first pair of offset portions, (2) that overlies the mount, and (3) that is inwardly offset to compensate for deflection that occurs to the deflection compensating refiner plate segment during operation of the rotary disk refiner.

13. The rotary disk refiner of claim 12 wherein the second offset portion of the refining surface is disposed at or adjacent the middle of the deflection compensating refiner plate segment.

14. The rotary disk refiner of claim 13 wherein the second offset portion of the refining surface is disposed along a midpoint of the refining surface of the deflection compensating refiner plate segment.

15. The rotary disk refiner of claim 12 wherein the plurality of spaced apart portions of the refining surface that are offset includes a third offset portion of the refining surface that is disposed between one of the offset portions of the first pair of offset portions and the second offset portion, and wherein the third offset portion of the refining surface is outwardly offset to compensate for deflection that occurs to the deflection compensating refiner plate segment during operation of the rotary disk refiner.

16. The rotary disk refiner of claim 7 wherein the deflection compensating refiner plate segment has a leading edge, a trailing edge, an outer edge, and an inner edge, and wherein one of the first pair of offset portions is disposed adjacent the leading edge, and another one of the first pair of offset portions is disposed adjacent the trailing edge.

17. The rotary disk refiner of claim 16 wherein each one of the first pair of offset portions has a portion of maximum offset that inwardly offsets the refining surface between two thousandths of an inch (0.05 mm) and fifteen thousandths of an inch (0.38 mm).

18. The rotary disk refiner of claim 17 wherein the portion of maximum offset of one of the first pair of offset portions is located adjacent the trailing edge of the deflection compensating refiner plate segment and the portion of maximum offset of another one of the first pair of offset portions is located adjacent the leading edge of the deflection compensating refiner plate segment.

19. The rotary disk refiner of claim 18 wherein the magnitude of the offset of each one of the first pair of offset portions decreases generally linearly from the portion of maximum offset.

20. The rotary disk refiner of claim 18 wherein the magnitude of the offset of each one of the first pair of offset portions decreases parabolically from the portion of maximum offset.

21. The rotary disk refiner of claim 1 wherein the rotary disk refiner is a conical disk refiner and the deflection compensating refiner plate segment comprises a deflection compensating conical disk refiner plate segment that has (1) a refining surface with a curvilinear transverse cross-sectional periphery, (2) a backside with a mount extending out therefrom defining a pair of spaced apart unsupported overhangs with one of the unsupported overhangs disposed along one side of the mount and the other one of the unsupported overhangs disposed along the other side of the mount, and (3) a pair of offset portions of the refining surface inwardly offset to compensate for deflection of the deflection compensating conical disk refiner plate segment with one of the pair of offset portions in one portion of the refining surface that is carried by one of the unsupported overhangs and another one of the pair of offset portions in another portion of the refining surface that is carried by the other one of the unsupported overhangs.

22. The rotary disk refiner of claim 21 wherein the deflection compensating conical disk refiner plate segment has a leading edge carried by one unsupported overhang and a trailing edge carried by the other unsupported overhang, and one of the pair of offset portions is disposed along the leading edge and another one of the pair of offset portions is disposed along the trailing edge.

23. The rotary disk refiner of claim 22 wherein the refining surface has one portion with a circular transverse cross-sectional periphery and each offset portion of the refining surface is inwardly offset relative to the one portion.

24. The rotary disk refiner of claim 23 wherein the one portion of the refining surface that has the circular transverse cross-sectional periphery comprises the majority of the refining surface.

25. The rotary disk refiner of claim 24 wherein during refiner operation at a rotational speed of at least 1500 rpm, each one of the pair of offset portions deflects outwardly a sufficient magnitude such that substantially all of the refining surface has a circular transverse cross-sectional periphery.

26. The rotary disk refiner of claim 23 wherein one of the pair of offset portions has a maximum offset adjacent the leading edge, the other one of the pair of offset portions has a maximum offset adjacent to the trailing edge, the one of the pair of offset portions encompasses a transverse region that extends a transversely inboard of the leading edge a distance of at least one inch (2.54 cm), and the other one of the pair of offset portions encompasses a transverse region that extends transversely inboard of the leading edge a distance of at least one inch (2.54 cm).

27. The rotary disk refiner of claim 26 wherein the magnitude of each one of the pair of offset portions at a distance of about one-half the length of its transverse region is between about one thousandth of an inch (0.05 mm) and about ten thousandths of an inch (0.25 mm).

28. The rotary disk refiner of claim 23 wherein the cross-sectional contour of each one of the pair of offset portions is within five percent of the result of the equation y=−0.0048x+0.0075 where the variable y represents the magnitude of the offset and the variable x represents the location of the offset relative to a symmetry plane or midpoint of the deflection compensating conical disk refiner plate segment.

29. The rotary disk refiner of claim 23 wherein the cross-sectional contour of each one of the pair of offset portions is within five percent of the result of the polynomial equation y=0.0007x³−0.0029x²−0.0014x+0.0068 where the variable y represents the magnitude of the offset and the variable x represents the location of the offset relative to a symmetry plane or midpoint of the deflection compensating conical disk refiner plate segment.

30. The rotary disk refiner of claim 1 wherein the deflection compensating refiner plate segment has a portion of its refining surface that is unsupported and the portion of the refining surface that is offset to compensate for deflection is disposed in that unsupported portion.

31. The rotary disk refiner of claim 30 wherein the rotary disk refiner is a conical disk refiner and the deflection compensating refiner plate segment comprises a deflection compensating conical disk refiner plate segment.

32. A refiner plate segment for a rotary disk refiner comprising:
a backside that includes a mounting portion that bears against or engages a mounting surface of the rotary disk refiner, the mounting portion providing support to the refiner plate segment;
a front side that includes a plurality of pairs of upraised and spaced apart refiner bars that defines a refining surface that is planar or that forms a segment of a conic section, the refining surface having a region that extends beyond the mounting portion such that the region is unsupported with the region deviating from planar or from the segment of the conic section to compensate for deflection of the refining surface that occurs during operation of the rotary disk refiner.

33. The refiner plate segment of claim 32 wherein the mounting portion comprises a dovetail mount, the refining surface has a pair of spaced apart regions each of which extends beyond the dovetail mount and each of which is unsupported, and the refining surface of each region is offset to compensate for deflection of the refining surface that occurs during operation of the rotary disk refiner.

34. The refiner plate segment of claim 33 wherein the refiner plate segment is a conical disk refiner plate segment with the refining surface forming the segment of the conic section and each offset region is offset from the segment of the conic section such that during operation of the rotary disk refiner, deflection of each offset region causes the refining surface in each offset region to substantially conform to the contour of the segment of the conic section such that the entire refining surface substantially conforms to the contour of the segment of the conic section.

35. The refiner plate segment of claim 32 wherein the refiner plate segment is a flat disk refiner plate segment that has a substantially planar refining surface except for a region deviating from planar, at least a portion of which is offset from planar to compensate for deflection during operation of the rotary disk refiner.

36. The refiner plate segment of claim 35 wherein the magnitude of the offset compensates for deflection of the refining surface during operation of the rotary disk refiner such that the entire refining surface becomes substantially planar during operation of the rotary disk refiner.

37. A refiner plate segment for a conical disk refiner comprising:
a front side that includes a plurality of pairs of upraised and spaced apart refiner bars that defines a refining surface that has a curvilinear transverse cross-sectional contour; and
a backside that comprises a pair of longitudinally extending mounting legs that are spaced apart to define a hollow therebetween that limits the deflection of that portion of the refining surface overlying the hollow.

38. The refiner plate segment of claim 37 wherein the pair of longitudinally extending mounting legs define a dovetail mount.

39. The refiner plate segment of claim 38 wherein the dovetail mount comprises a tenon that is received in a mortise of the conical disk refiner.

40. The refiner plate segment of claim 37 wherein the hollow has a concave transverse cross-sectional contour.

41. The refiner plate segment of claim 37 wherein the backside further comprises a pair of transversely extending and spaced apart ribs that are each disposed between the mounting legs.

42. The refiner plate segment of claim 41 wherein each one of the ribs extends from one of the mounting legs to the other one of the mounting legs.

43. The refiner plate segment of claim 42 wherein the hollow has a concave shape.

44. A method of making a deflection compensating refiner plate segment comprising:
(a) providing a refiner plate segment that has a refining surface defining by a plurality of upraised and spaced apart refiner bars disposed on a front side of the refiner plate segment and a mounting surface that is capable of contacting a rotor of a rotary disk refiner;
(b) determining where the refining surface of the refiner plate segment deflects when subjected to a centrifugal force imparted on the refiner plate segment when the refiner plate segment is rotated at a rotational speed of 1500 rpm; and
(c) offsetting the refining surface in each portion of the refining surface where it has been determined that it deflects in step (b).

45. The method of making a deflection compensating refiner plate segment of claim 44 wherein (1) the deflection compensating refiner plate segment has a backside with a mount extending from the backside, (2) the refining surface has an overhang region that extends beyond the mount, and (3) at least a portion of the overhang region of the refining surface is offset to compensate for deflection that occurs during refiner operation.

46. The method of making a deflection compensating refiner plate segment of claim 45 wherein the portion of the overhang region of the refining surface that is offset, is offset at least about two thousandths of an inch (0.05 mm) relative to another portion of the refining surface.

47. The method of making a deflection compensating refiner plate segment of claim 45 wherein a transverse cross-sectional periphery of the majority of the refining surface defines a section of a circle, and the portion of the overhang region of the refining surface that is offset, is offset at least about two thousands of an inch (0.05 mm) relative to the section of the circle at a location of maximum offset.

48. The method of making a deflection compensating refiner plate segment of claim 47 wherein, during refiner operation at a rotational speed of at least 1500 rpm, the portion of the overhang region of the refining surface that is offset deflects such that substantially the entire refining surface defines the section of the circle.

49. The method of making a deflection compensating refiner plate segment of claim 47 wherein the magnitude of the offset of the portion of the overhang region that is offset corresponds to the function y=0.0007x³−0.0029x²−0.0014x+0.0068 wherein y is the magnitude of the offset and x is the transverse distance from a centerline or symmetry plane of the segment.

50. The method of making a deflection compensating refiner plate segment of claim 47 wherein the magnitude of the offset of the portion of the overhang region that is offset is within ±5% of the result of the function y=−0.0048x+0.0075 wherein y is the magnitude of the offset and x is the transverse distance from a centerline or symmetry plane of the segment.

51. The method of making a deflection compensating refiner plate segment of claim 45 wherein the deflection compensating refiner plate segment has an edge, the overhang region extends outwardly to the edge, the portion of the overhang region of the refining surface that is offset has a maximum offset adjacent the edge that is at least two thousandths of an inch (0.05 mm).

52. The method of making a deflection compensating refiner plate segment of claim 51 wherein the maximum offset is no greater than fifteen thousandths of an inch (0.38 mm).

53. The method of making a deflection compensating refiner plate segment of claim 45 wherein the refining surface has a pair of overhang regions that each extending transversely beyond the mount and at least a portion of each overhang region of the refining surface is offset to compensate for deflection that occurs during refiner operation.

54. The method of making a deflection compensating refiner plate segment of claim 53 wherein the segment is a conical disk refiner plate segment that is mounted to a rotor of a conical disk refiner and rotated about an axis of rotation at a rotational speed of at least 1500 rpm during refiner operation.

55. The method of making a deflection compensating refiner plate segment of claim 44 wherein the method further comprises in step (b) determining the magnitude of the deflection.

56. The method of making a deflection compensating refiner plate segment of claim 55 wherein the refiner disk segment is modeled using finite element analysis in step (b).

57. The method of making a deflection compensating refiner plate segment of claim 56 wherein a transverse cross-section of the refiner plate segment is modeled by fitting a mesh to it and rotating it in a computer simulation at a rotational speed of 1500 rpm or greater.

58. The method of making a deflection compensating refiner plate segment of claim 57 wherein, before rotation of the modeled refiner plate segment in a computer simulation, boundary conditions for the modeled refiner plate segment are defined and include a density of about 7800 kg per cubic meter and a coefficient of friction between a mount of the modeled refiner plate segment and a refiner plate holder of about 0.2.

59. The method of making a deflection compensating refiner plate segment of claim 58 further comprising defining an additional boundary condition of between 5 to 10 atmospheres of steam pressure in a refining zone between the modeled refiner plate segment and a refiner plate segment opposing the modeled refiner plate segment.

60. The method of making a deflection compensating refiner plate segment of claim 56 wherein the magnitude and location of deflection of the refining surface is a result of the function y=0.0007x³−0.0029x²−0.0014x+0.0068 wherein y is the magnitude of the deflection and x is the transverse distance from a centerline or symmetry plane of the refiner plate segment.

61. The method of making a deflection compensating refiner plate segment of claim 56 wherein the magnitude and location of deflection of the refining surface is approximated by the function y=−0.0048x+0.0075 wherein y is the magnitude of the deflection and x is the transverse distance from a centerline or symmetry plane of the segment.

62. The method of making a deflection compensating refiner plate segment of claim 61 wherein the magnitude and location of the deflection of the refining surface is within ±5% of the function y=−0.0048x+0.0075.

63. The method of making a deflection compensating refiner plate segment of claim 44 wherein in step (b) the location and magnitude of refiner surface deflection is determined using a refiner plate segment that has a refining surface fitted with a plurality of pairs of refiner gap sensors that is rotated in a rotary disk refiner at a rotational speed of at least 1500 rpm to measure the refiner gap along the refining surface.

64. The method of making a deflection compensating refiner plate segment of claim 44 wherein in step (b) the location and magnitude of refiner surface deflection is determined and in step (c) an offset is applied to the refining surface in each location that is proportional to the determined magnitude.
